(19) United States
(12) Patent Application Publication
(10) Pub. No.: US 2025/0225001 A1
(43) Pub. Date: Jul. 10, 2025

(54) METHODS AND APPARATUS TO ESTIMATE POWER CONSUMPTION OF AN APPLICATION IN A COMPUTING ENVIRONMENT

(71) Applicant: Intel Corporation, Santa Clara, CA (US)

(72) Inventors: Thijs Metsch, Bruehl (DE); Christopher Michael MacNamara, Limerick (IE); John Joseph Browne, Limerick (IE); Adrian Christopher Hoban, Cratloe (IE)

(73) Assignee: Intel Corporation, Santa Clara, CA (US)

(21) Appl. No.: 19/094,591

(22) Filed: Mar. 28, 2025

(51) Int. Cl. G06F 9/50

(52) U.S. Cl. CPC G06F 9/5094

(57) ABSTRACT

An example apparatus includes interface circuitry to obtain a power draw of a node, telemetry data of a core in the node, and an application characteristic of an application, and a programmable circuit to determine a first weight based on the telemetry data and the application characteristic, the first weight indicative of an impact the application has on a power consumption of the core, determine a second weight based on the application characteristic, the second weight indicative of an impact the application has on a power consumption of resources accessible by the core and by different cores of the node, determine a power estimate value for the application based on the first weight, the second weight, the power consumption of the core, and the power consumption of the resources, the power estimate value indicative of how much power of the power draw of the node that the application draws.

### FIELD OF THE DISCLOSURE

This disclosure relates generally to applications in computing environments and, more particularly, to estimating power consumption of an application in a computing environment.

### BACKGROUND

In computing, including in edge and cloud computing, a node refers to a single computing device, whether physical or virtual, located within a data center or at an edge of a network, which acts as a point of processing, storage, data exchange, etc. A node can be a server, a gateway, or an Internet of Things (IoT) device. A node includes one or more cores. A core refers to a processing unit, such as a central processing unit (CPU), within the node that is responsible for performing calculations and executing instructions related to active workloads. In some examples, a node includes a plurality of cores and may be referred to as a “multicore node” or a “multicore processor”. Multicore nodes may execute a plurality of active workloads simultaneously.

### BRIEF DESCRIPTION OF THE DRAWINGS

FIG. 1 is a block diagram of an example power estimation environment in which example power estimation circuitry operates to estimate power consumption on a per application basis.

FIG. 2 is a block diagram of an example implementation of the power estimation circuitry of FIG. 1 to estimate power consumption on a per application basis.

FIG. 3 is an example bar graph and an example power signal plot that depict a distribution of an example power draw among three different applications running on the node of FIG. 1.

FIGS. 4-6 are flowcharts representative of example machine readable instructions and/or example operations that may be executed, instantiated, and/or performed by example programmable circuitry to implement the power estimation circuitry 102 of FIG. 2.

FIG. 7 is a block diagram of an example processing platform including programmable circuitry structured to execute, instantiate, and/or perform the example machine readable instructions and/or perform the example operations of FIGS. 4-6 to implement the power estimation circuitry 102 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A node includes one or more cores, which are processing units within the node that perform calculations and execute instructions related to active workloads. In a multicore node, the cores may “share” a collection of components or resources essential for core performance but not included in the core. As used herein, the verb “share” refers to one core using and/or accessing the same collection of components and/or resources as one or more other cores in the node. For example, the components included in the core that may not be shared and are involved in executing instructions include execution units, level one (L1) and level two (L2) cache, branch prediction logic, etc. Some components and/or resources may not be included in the core and, thus, shared with other cores, such as: last level cache (LLC), memory controllers (e.g., integrated memory controllers), on-chip interconnect (OCI), power control logic (PWR), etc. As used herein, a collection of components not included in the core but used and/or accessible by the cores is referred to as “non-core resources”.

In some systems, a power draw of a node can be measured, a power consumption of a core can be measured, and a power consumption of the non-core resources can be measured. However, in some systems, a power draw of an active workload executed by the node, core, and/or non-core cannot be measured and, thus, is to be estimated.

Estimating how much power an active workload causes the node to draw is challenging because the power draw of a node does not increase linearly with the number of active workloads running on the node. For example, a multicore node may execute a plurality of workloads, where each workload may draw a different amount of power due to different application requirements (e.g., priority, service level objectives (SLOs), power profile, etc.). During the activation of a first core to execute a first workload, there is often a spike or substantial increase in power of the multicore node. The spike is a result of the first core and the non-core resources entering a high-power state. When a second core is activated to execute a second workload later in time, the increase in power may only be minimal relative to the initial increase shown during activation of the first core. In some examples, this is because the non-core resources were already activated and remained in a high-state, so the minimal increase in power shown relates to the activation of the second core rather than activation of both the second core and the non-core resources. Additionally and/or alternatively, the minimal increase in power is due to the second core not consuming as much power as the first core. For example, some cores are big (e.g., high performance and, thus, high power consumption) and some cores are small (e.g., low performance and, thus, lower power consumption). Additionally and/or alternatively, the minimal increase in power is due to the second workload not requiring as much usage of non-core resources as the first workload.

As described above, determining the power estimate of a workload based on the power draw of the node is challenging because there are many factors that play a role in the power draw of the node. However, addressing the challenge is important for a few reasons. The first reason is related to managing and orchestrating node. When the impact of workloads is not accounted for, an administrator may not understand how to individually manage the non-core resources of the node and may not understand how to distribute the workloads across cores in the node. As a result, the administrator cannot orchestrate the workloads in a manner that improve power efficiency within the node. The second reason is related to monitoring and accounting for energy costs. For example, without accurate power attribution, reliably assigning energy costs to applications and building carbon footprint estimations in compliance with energy efficiency initiatives, such a green computing, becomes difficult and inaccurate. If an accurate estimate of power consumption of workloads does not exist, then a proper carbon footprint cannot be built and reported. The third reason is related to power capping workloads. For example, some workload administrators and/or users of workloads want to cap or limit the power the application draws, such as requesting that application A does not draw more than 100 W per hour. Without a power estimate of application A, the administrator and/or user does not know if application A is drawing more than 100 W per hour.

Examples disclosed herein estimate power consumption on a per application basis. As used herein, “workload” and “application” are used interchangeably and refer to a type of processing that a core performs and the amount of work that the node needs to do to complete tasks assigned by the workload and/or application. Examples disclosed herein estimate the power consumption of an application based on weighting the power consumption of the core and the power consumption of the non-core resources, the weights determined based on characteristics of the application and characteristics of the core. As used herein, application characteristics refer to at least one of a priority level of the application, theoretical power profile given to the application, service level objectives of the application, allotted resource usage for the application, allotted number of cores the application can use, and/or data-intensity of the application. However, the application characteristics are not limited to those listed above. As used herein, the core characteristics refer to at least one of the identifier number of the core (e.g., CPUID, SKU information, etc.), time the core spends in an idle power saving mode (e.g., C-state residency), time the core spends in a performance mode (e.g., P-state residency), and/or a level of activity the core dedicated to processing network packets (e.g., busyness of the core). However, the core characteristics are not limited to those listed above.

Examples disclosed herein receive inputs from various sources to weight the power consumption of the core and of the non-core resources. Examples disclosed herein obtain telemetry data and resource allocation information from the node, obtain application characteristics from orchestration and management systems, and obtain user inputs including node and/or core specifications and user preferences for weighting. These inputs enable precise or near precise power measurement per application, which provides the basis for finer grain decision making in orchestration and management stacks for cloud and edge environments, provides the ability to estimate and report carbon footprints in compliance with policies such as European Union acts on emissions, enables cluster-level optimizations for applications, and enables application optimizations in general. Examples disclosed herein enable cluster-level optimizations by providing information (e.g., power consumption per application) that indicates which applications can be co-located or clustered based on their power consumption (e.g., applications in power saving mode can be grouped while applications in active mode can be grouped). Also, examples disclosed herein enable general optimizations by providing information (e.g., power consumption per application) indicative of which applications should be refactored for an energy efficient design.

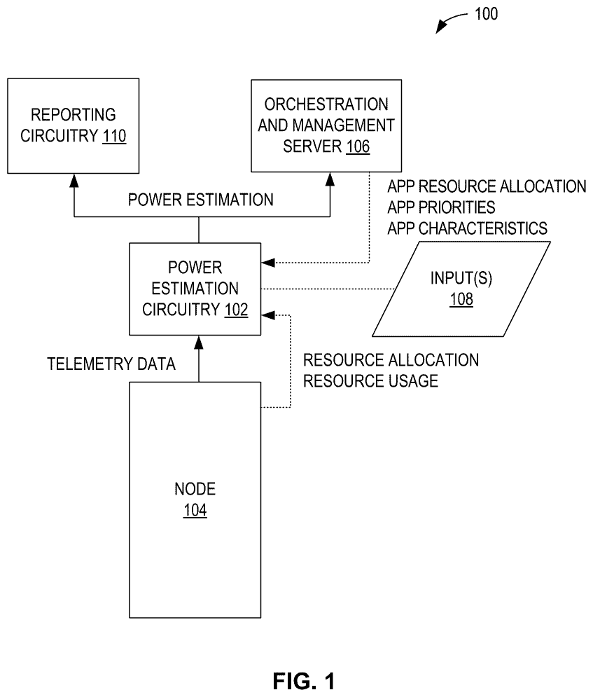

FIG. 1 is a diagram of an example power estimation system 100 in which example power estimation circuitry 102 operates to estimate power consumption on a per application basis. The power estimation system 100 includes an example node 104, an example orchestration and management server 106, example input(s) 108, and example reporting circuitry 110. While the example estimates power consumption on a per application basis, power may be estimated based on other divisions such as power consumed for a portion of the node 104 (e.g., server), for a full node 104, and/or for a portion of a rack of servers (including or excluding other rack equipment such as switches, etc.).

In the illustrated example of FIG. 1, the power estimation system 100 represents a computing infrastructure, such as a cloud computing infrastructure, an edge computing infrastructure, or a local computing infrastructure. In any computing infrastructure, hardware and virtualized hardware, such as the node 104, can access computing services over a network (e.g., the Internet). Therefore, components of the power estimation system 100 communicate via a network to estimate power consumption on a per application basis.

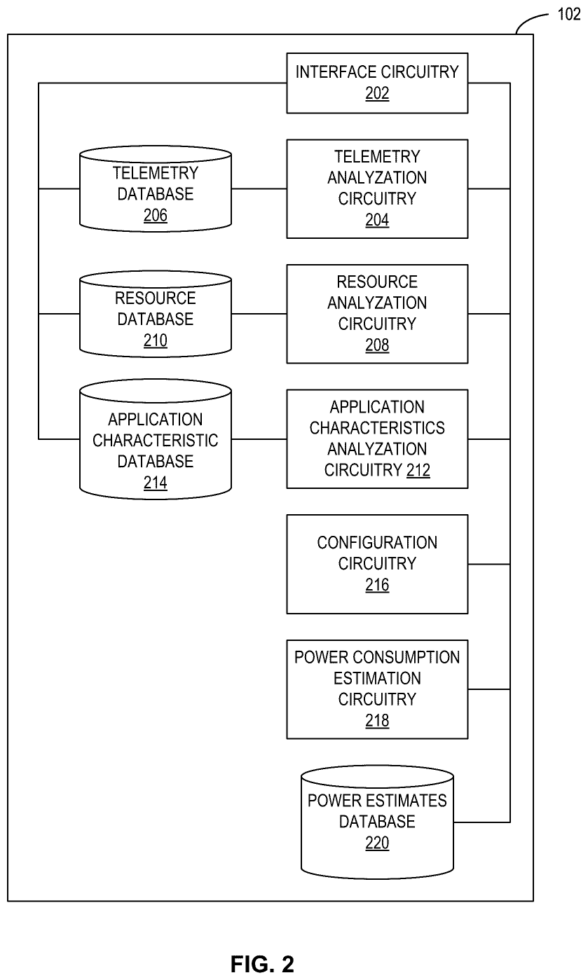

In the illustrated example of FIG. 1, the power estimation circuitry 102 estimates power consumption of one or more applications (e.g., workloads) executing on the node 104. In some examples, the power estimation circuitry 102 is provided by the power estimation system 100 to improve the operation of the node 104 and the operation of the orchestration and management server 106. For example, when the power estimation system 100 is a cloud computing environment or an edge computing environment, the power estimation circuitry 102 is included to improve a service (PaaS) layer or as a software as a service (SaaS) layer. PaaS refers to cloud computing services that supply an on-demand environment for developing, testing, delivering, and managing software applications. SaaS is a method for delivering software applications over the network, where cloud or edge providers host and manage the software application and underlying infrastructure, and handle any maintenance (e.g., like software upgrades and security patching) and users connect to the application over the network, usually with a web browser on their computing device (e.g., phone, tablet, or personal computer). In some examples, the orchestration and management server 106 implements the PaaS and/or Saas layers. As such, power estimates for each application running at the node 104 improve the operation of the orchestration and management server 106 and, in turn, improves the operation of the node 104. The power estimation circuitry 102 is described in further detail below in connection with FIGS. 2-6.

In the illustrated example of FIG. 1, the node 104 is a single computing device, whether physical or virtual, located at an edge of a network or within a data center, which acts as a point of processing, storage, and data exchange. In this example, the node 104 is a server executing one or more applications. Additionally and/or alternatively, the node 104 is a gateway, an IoT device, etc. In this example, the node 104 is a multi-core node 104, having two or more cores and a collection of additional resources, such as non-core resources, network interface cards, input/output (I/O) device, infrastructure processing unit (IPU), etc. As described above, non-core resources are the collection of components essential for core performance but not included in the core and, thus, shared with other cores, such as the last level cache (LLC), memory controller (e.g., integrated memory controllers), on-chip interconnect (OCI), power control logic (PWR), etc.

In the illustrated example, the node 104 communicates information to the power estimation circuitry 102. For example, the node 104 sends telemetry data to the power estimation circuitry 102. The telemetry data includes any raw metrics of the node 104, including power consumption of the node 104, power consumption of each of the cores, power consumption of the non-core resources, C-state residency of the cores (e.g., idle time), P-state residency of the cores (e.g., active time), resource utilization (e.g., CPU usage, memory consumption, network bandwidth, and disc space), busyness of the cores, etc. In some examples, the node 104 communicates operating system (OS) information to the power estimation circuitry 102. For example, OS information includes resource allocation data, such as how many cores have been allocated to the applications and how many portions of cores have been allocated to the applications, and resource usage data, such as how many cores an application is executing on and what type of cores an application is executing on (e.g., CPU, accelerator, etc.). In some examples, the node 104 is prompted by the power estimation circuitry 102 to send telemetry data and OS data. Additionally and/or alternatively, the node 104 automatically provides the telemetry data and OS data to the power estimation circuitry 102.

In the illustrated example of FIG. 1, the orchestration and management server 106 manages the deployment, configuration, scaling, and monitoring of hardware (e.g., the node 104) and applications across the power estimation system 100. As described above, the orchestration and management server 106 may implement different orchestration and management services, such as PaaS, SaaS, etc. In some examples, the orchestration and management server 106 creates and manages automated workflows within the system 100, allocates and manages computing resources (e.g., servers such as node 104, storage, network) across different computing environments as needed by the workflow, deploys applications and updates configurations consistently across multiple servers (e.g., two or more nodes 104), tracks the status of running workflows, identifies potential issues, and triggers alerts when necessary, and dynamically scales up or down resources based on workload demands. In some examples, the orchestration and management server 106 is implemented by software and may run on the node 104.

In the illustrated example, the orchestration and management server 106 communicates information to the power estimation circuitry 102. For example, the orchestration and management server 106 sends application characteristics to the power estimation circuitry 102. As described above, application characteristics refer to at least one of a priority level of the application, theoretical power profile given to the application, service level objectives of the application, allotted resource usage for the application, allotted number of cores the application can use, and data-intensity of the application. In some examples, the orchestration and management server 106 have application characteristics in order to better manage and orchestrate the workflows throughout the power estimation system 100. Advantageously, the orchestration and management server 106 receive the power estimations of the applications that it is orchestrating and managing, and can use those power estimations to improve the workflows.

As used herein, the orchestration and management server 106 may be referred to as an “orchestration server”, a “management server”, or an “orchestration node”.

In the illustrated example of FIG. 1, the input(s) 108 are user inputs corresponding to specifications of the node 104 and preferences for weighting techniques to be applied during power estimation of the applications. For example, the inputs 108 include estimated power curves of the cores implemented by the node 104. An estimated power curve refers to a graphical representation showing the maximum power a computer processor core can output over different time durations. The power curve is estimated by a manufacturer of the core and illustrates how much processing power is consumed relative to core load conditions.

Additionally, the inputs 108 include identifier numbers of the core, such as a stock keeping unit (SKU) number. The SKU number is a unique number assigned to each product variation within a retailer's inventory. For example, the SKU number of a processor core represents a specific variant within a processor generation (e.g., a specific release period of a processor model), indicating the core's unique configuration and performance level within that generation. In some examples, a first SKU number indicates a first configuration of cores and non-core resources, and a second SKU number indicates a second configuration of cores and non-core resources. The first configuration corresponding to the first SKU number may represent four cores grouped together and using one set of non-core resources. The second configuration corresponding to the second SKU number may represent two groups of two cores, where the first group of two cores accesses one set of non-core resources and the second group of two cores accesses a different set of non-core resources. In some examples, when the SKU number indicates that a package has multiple sets of non-core resources, and one set of the non-core resources causes a power draw of the package to increase, the one or more applications using (e.g., accessing) that set of non-core resources is to be attributed a greater fraction of the overall power of the package. In such an example, the one or more applications using the second set of non-core resources should not be attributed a big fraction of the overall power of the package. Therefore, the different identifiers of the core (e.g., the SKU numbers) can be used to define the weights for the power consumption of the core and of the non-core resources.

Additionally, the inputs 108 include minimum and maximum frequency settings of the cores. The minimum frequency setting of a core refers to the base clock speed or standard operating speed of the core. The maximum frequency setting of the core refers to the highest clock speed the core should be permitted to reach (e.g., typically subject to the CPU's internal power management/protection circuitry).

Additionally, the inputs 108 include user preferences for defining the weighting techniques to be applied during power estimation of the applications. For example, users and/or administrators of the node 104 may input a thresholding mechanism that helps defines weights for different scenarios. For example, users and/or administrators may separate weights based on different application characteristic and core characteristic scenarios. For example, a first weight associated with the power consumption of the core (e.g., a core weight) can be adjusted based on the identifier of the core and how many sets of non-core resources the identifier indicates. And a second weight associated with the power consumption of the non-core resources (e.g., non-core weight) can be adjusted based on the priority level of the application. In some examples, users may define how much to adjust the weights based on the scenarios. For example, a user can define that an application which is less dependent on the non-core resources should have a non-core weight with a small value (e.g., less than 0.5). In some examples, the inputs 108 include preferences to map power consumption to carbon footprints of an application, to greenhouse gas emissions of an application, etc.

The user preferences of the inputs 108 are described in further detail below in connection with FIG. 2. In some examples, the inputs 108 are provided to the power estimation circuitry 102 through rest application programming interfaces (APIs), command line interfaces (CLIs), or any other interface.

In the illustrated example of FIG. 1, the reporting circuitry 110 reports the power consumption of the applications to users and/or administrators. In some examples, the reporting circuitry 110 provides direct access to users and administrators regarding the power consumption of their applications. In such examples, the reporting circuitry 110 may be implemented by interface circuitry and connected to one or more output devices (e.g., display devices, printers, speakers, etc.). In some examples, the reporting circuitry 110 reports carbon footprint estimations of the applications to users and administrators. For example, if the inputs 108 request a mapping of carbon footprint to power consumption, the reporting circuitry 110 reports the carbon footprint estimations of the applications. In some examples, the reporting circuitry 110 reports power saving strategies for the node 104 based on the power estimations of the applications. The reporting circuitry 110 may generate any type of report based on the power estimations of the applications.

FIG. 2 is a block diagram of an example implementation of the power estimation circuitry 102 of FIG. 1 to estimate power consumption on a per application basis. The power estimation circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the power estimation circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The power estimation circuitry 102 of FIG. 2 includes example interface circuitry 202, example telemetry analyzation circuitry 204, an example telemetry database 206, example resource analyzation circuitry 208, an example resource database 210, example application characteristics analyzation circuitry 212, example application characteristic database 214, example configuration circuitry 216, example power consumption estimator circuitry 218, and an example power estimates database 220.

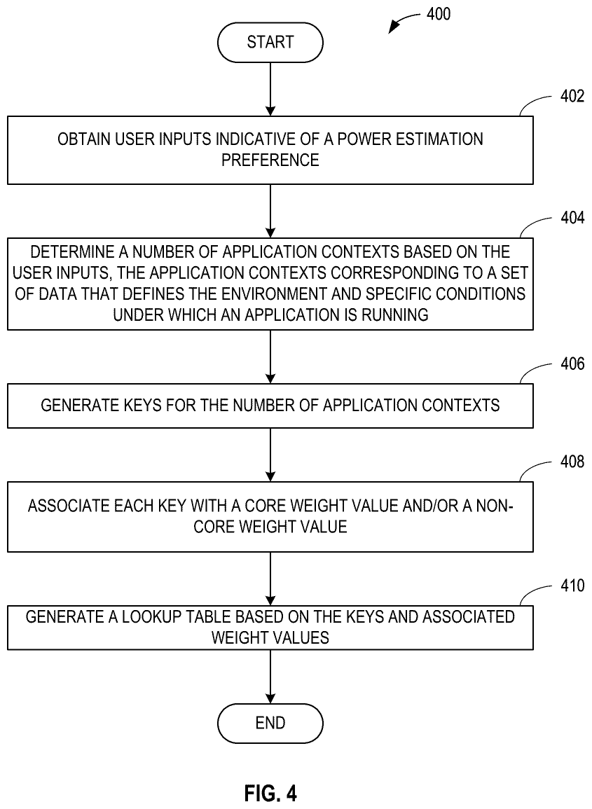

In some examples, the interface circuitry 202 is instantiated by programmable circuitry executing interface circuitry instructions and/or configured to perform operations such as those represented by the flowcharts of FIGS. 4-6.

In some examples, the telemetry analyzation circuitry 204 is instantiated by programmable circuitry executing telemetry analyzation circuitry instructions and/or configured to perform operations such as those represented by the flowcharts of FIGS. 4-6.

In some examples, the resource analyzation circuitry 208 is instantiated by programmable circuitry executing resource analyzation circuitry instructions and/or configured to perform operations such as those represented by the flowcharts of FIGS. 4-6.

In some examples, the application characteristics analyzation circuitry 212 is instantiated by programmable circuitry executing application characteristics analyzation circuitry instructions and/or configured to perform operations such as those represented by the flowcharts of FIGS. 4-6.

In some examples, the configuration circuitry 216 is instantiated by programmable circuitry executing configuration circuitry instructions and/or configured to perform operations such as those represented by the flowcharts of FIGS. 4-6.

In some examples, the power consumption estimator circuitry 218 is instantiated by programmable circuitry executing power consumption estimator circuitry instructions and/or configured to perform operations such as those represented by the flowcharts of FIGS. 4-6.

In the illustrated example of FIG. 2, the interface circuitry 202 obtains data from the node 104 (FIG. 1), the orchestration and management server 106 (FIG. 1), and user inputs 108 (FIG. 1). In some examples, the interface circuitry 202 sends data to the reporting circuitry 110 (FIG. 1). In some examples, the interface circuitry 202 stores data in one or more of the telemetry database 206, resource database 210, application characteristic database 214. For example, the interface circuitry 202 stores telemetry data in the telemetry database 206, OS information and resource information in the resource database 210, and application characteristics in the application characteristic database 214.

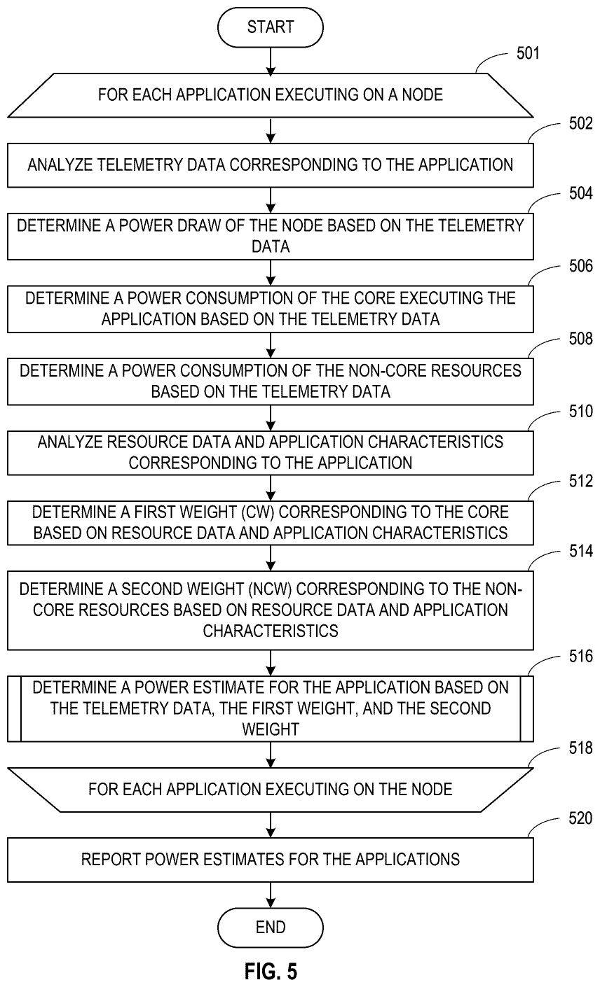

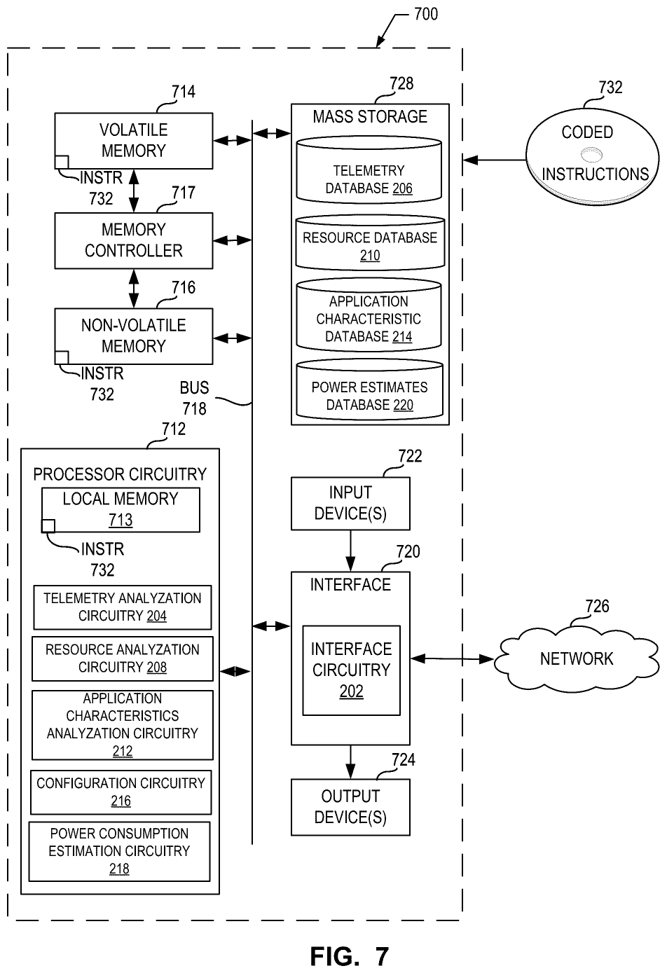

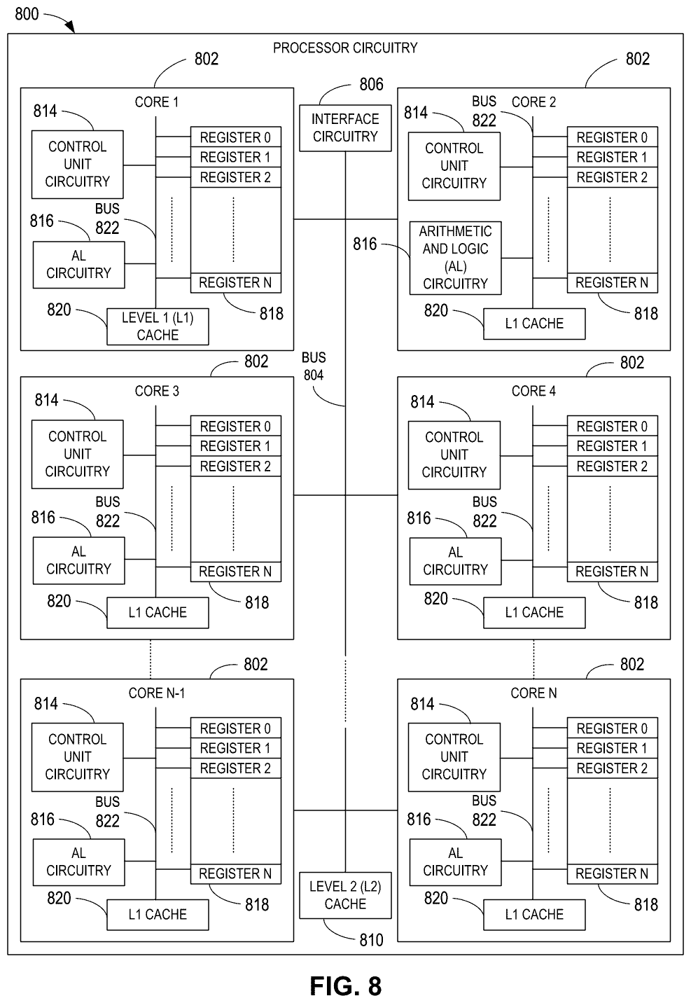

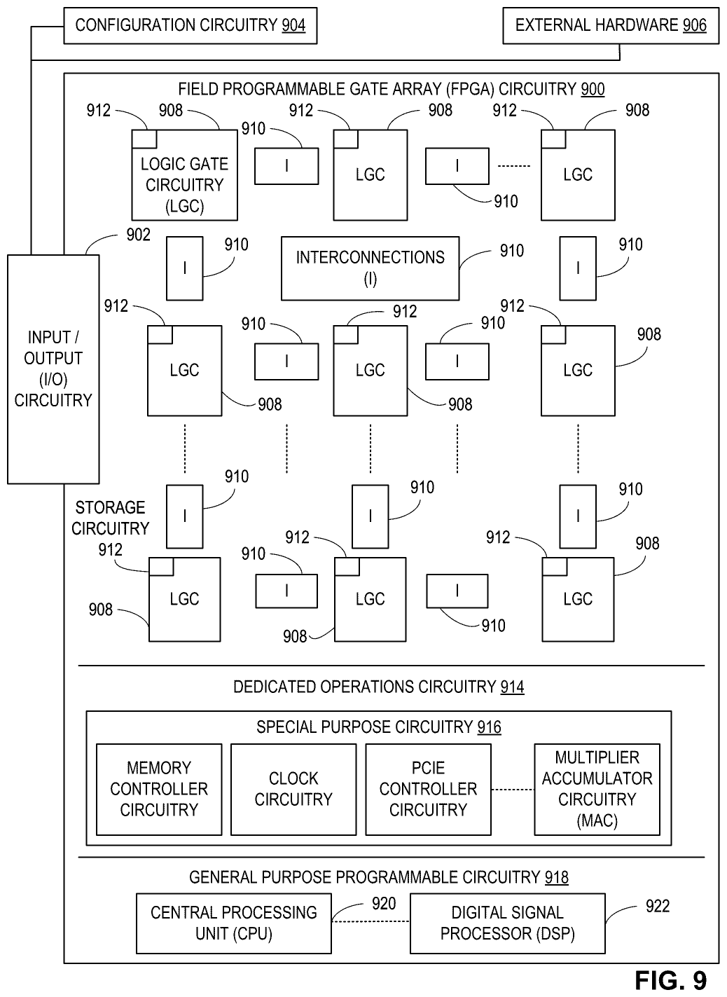

In some examples, the power estimation circuitry 102 includes means for obtaining telemetry data and application characteristic data. For example, the means for obtaining telemetry data and application characteristic data may be implemented by interface circuitry 202. In some examples, the interface circuitry 202 may be instantiated by programmable circuitry such as the example programmable circuitry 712 of FIG. 7. For instance, the interface circuitry 202 may be instantiated by the example microprocessor 800 of FIG. 8 executing machine executable instructions such as those implemented by at least blocks 402 of FIG. 4 and 520 of FIG. 5. In some examples, the interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the interface circuitry 202 may be instantiated by any other combination of hardware, software, and/or firmware. For example, the interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the telemetry analyzation circuitry 204 analyzes telemetry data, stored in the telemetry database 206, and outputs relevant information to the power consumption estimation circuitry 218. For example, the telemetry analyzation circuitry 204 extracts a power draw of the node 104 from the telemetry data. In some examples, the telemetry analyzation circuitry 204 determines the power draw of the node 104 based on power consumption metrics, voltage and current readings from a power supply unit of the node 104, etc. In some examples, the telemetry analyzation circuitry 204 determines the power consumption of a core executing an application based on individual core power usage metrics, such as CPU core power. In some examples, the telemetry analyzation circuitry 204 determines the power consumption of the non-core resources based on available options from the CPU. This could include metrics related to the non-core as a whole, or for sub-systems of non-core resources such as the last level cache, the integrated memory controllers, the on-chip interconnect, and/or the power control logic. In some examples, the telemetry analyzation circuitry 204 determines the number of active cores in the node 104 based on the telemetry data. For example, the telemetry analyzation circuitry 204 analyzes the residencies (e.g., C-state residencies) of the cores in the node 104 to determine an active core count. For example, the C-state residencies would be an indicator of activity of the core (e.g., C=0 means the core is fully active).

In some examples, the telemetry analyzation circuitry 204 sends the power draw data, the power consumption of the core data, and the power consumption of the non-core resources data to the power consumption estimation circuitry 218 for use in determining the power consumption of an application. In some examples, when the power consumption estimation circuitry 218 determines power consumption for multiple applications executing on the node 104, the power consumption estimation circuitry 218 uses the same power draw data, the power consumption of the core data, and the power consumption of the non-core resources data across the applications. In some examples, the power consumption of the core differs per application. For example, when core 1 is executing application A and core 2 is executing application B. In such an example, the telemetry analyzation circuitry 204 determines the power consumption of core A and the power consumption of core B, and sends that data to the power consumption estimation circuitry 218.

In some examples, the power estimation circuitry 102 includes means for determining a power consumption of a core and a power consumption of non-core resources based on telemetry data. For example, the means for determining a power consumption of a core and a power consumption of non-core resources based on telemetry data may be implemented by telemetry analyzation circuitry 204. In some examples, the telemetry analyzation circuitry 204 may be instantiated by programmable circuitry such as the example programmable circuitry 712 of FIG. 7. For instance, the telemetry analyzation circuitry 204 may be instantiated by the example microprocessor 800 of FIG. 8 executing machine executable instructions such as those implemented by at least blocks 502, 504, 506, and 508 of FIG. 5. In some examples, telemetry analyzation circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the telemetry analyzation circuitry 204 may be instantiated by any other combination of hardware, software, and/or firmware. For example, the telemetry analyzation circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the telemetry database 206 stores telemetry data. In some examples, the telemetry database 206 is a cache located closer to the telemetry analyzation circuitry 204 and, thus, is quickly accessible. The telemetry database 206 of FIG. 2 is implemented by any memory, storage device and/or storage disc for storing data such as, for example, flash memory, magnetic media, optical media, solid state memory, hard drive(s), thumb drive(s), etc. Furthermore, the data stored in the telemetry database 206 may be in any data format such as, for example, binary data, comma delimited data, tab delimited data, structured query language (SQL) structures, etc. While, in the illustrated example, the example telemetry database 206 is illustrated as a single memory, the telemetry database 206 and/or any other data storage devices described herein may be implemented by any number and/or type(s) of memories. The telemetry database 206 may implement the means for storing telemetry data from a node.

In the illustrated example of FIG. 2, the resource analyzation circuitry 208 analyzes raw resource data, stored in the resource database 210, and outputs relevant information to the power consumption estimation circuitry 218. For example, the resource analyzation circuitry 208 extracts unprocessed resource utilization metrics from the data provided by the telemetry data or the operating system of the node 104 and determines a resource utilization value of cores based on that data. For example, the resource analyzation circuitry 208 obtains data corresponding to CPU cycles, memory bytes, disk I/O operations, etc., and determines a percentage of usage for each of those resources. For example, the CPU is a resource, the disk is a resource, and the memory is a resource. The usage of the CPU can be determined by analyzing the number of cycles over a time period, the usage of the disk can be determined by analyzing the number of input/output operations over a time period, and the usage of memory can be determined by analyzing the number of memory bytes used over a time period. Therefore, the resource analyzation circuitry 208 determines whether the usage of the core is 1%, 5%, 50%, 70%, etc., based on the CPU cycles. The resource analyzation circuitry 208 determines whether the usage of the disk is 1%, 5%, 50%, 70%, etc., based on the disk I/O operations. The resource analyzation circuitry 208 determines whether the usage of the memory is 1%, 5%, 50%, 70%, etc., based on the memory bytes. In some examples, the resource analyzation circuitry 208 determines resource utilization for any other resources not mentioned above and that are relevant to estimating the power consumption of an application.

In some examples, the resource analyzation circuitry 208 analyzes resource allocation data to determine how many cores have been allocated to an application under analysis. In some examples, the resource allocation data provides the power consumption estimation circuitry 218 with information on how much power the application needs to execute. For example, if the resource analyzation circuitry 208 determines that application A is allocated one core and application B is allocated three cores, then it is likely that application A requires less power to execute than application B requires over a same time period. Additionally, if the resource analyzation circuitry 208 determines that application A is allocated 100 bytes of memory and application B is allocated 50 bytes, then it is likely that application A requires more non-core resource power consumption than application B requires and application A can be attributed more non-core resource power consumption. In some examples, the power consumption estimation circuitry 218 uses the resource allocation data to determine weights for the core power consumption and the non-core resource power consumption, as described in further detail below.

In some examples, the resource analyzation circuitry 208 analyzes. Resource usage data differs from resource utilization data in the sense that resource utilization data is indicative of how much a resource is being used (e.g., 10%, 20%, 80%, etc.) whereas resource usage data is indicative of a number of resources and the type of resources used for a specific application. The power consumption estimation circuitry 218 can use the resource usage data to determine weights for the core power consumption and the non-core resource power consumption for a specific application.

In some examples, the power estimation circuitry 102 includes means for determining a resource utilization and a resource allocation of resources in a node. For example, the means for determining a resource utilization and a resource allocation of resources in a node may be implemented by resource analyzation circuitry 208. In some examples, the resource analyzation circuitry 208 may be instantiated by programmable circuitry such as the example programmable circuitry 712 of FIG. 7. For instance, the resource analyzation circuitry 208 may be instantiated by the example microprocessor 800 of FIG. 8 executing machine executable instructions such as those implemented by at least block 510 of FIG. 5. In some examples, the resource analyzation circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the resource analyzation circuitry 208 may be instantiated by any other combination of hardware, software, and/or firmware. For example, the resource analyzation circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the resource database 210 stores raw (e.g., unprocessed) resource allocation data and raw resource utilization data. In some examples, the resource database 210 is a cache located closer to the resource analyzation circuitry 208 and, thus, is quickly accessible. The resource database 210 of FIG. 2 is implemented by any memory, storage device and/or storage disc for storing data such as, for example, flash memory, magnetic media, optical media, solid state memory, hard drive(s), thumb drive(s), etc. Furthermore, the data stored in the telemetry database 206 may be in any data format such as, for example, binary data, comma delimited data, tab delimited data, structured query language (SQL) structures, etc. While, in the illustrated example, the example telemetry database 206 is illustrated as a single memory, the resource database 210 and/or any other data storage devices described herein may be implemented by any number and/or type(s) of memories. The resource database 210 may implement the means for storing resource data from a node.

In the illustrated example of FIG. 2, the application characteristics analyzation circuitry 212 analyzes application characteristics, stored in the application characteristic database 214, and outputs relevant information to the power consumption estimation circuitry 218. In some examples, relevant application characteristic information includes application characteristics corresponding to the application under analysis. For example, if the node 104 is executing both application A and application B, the application characteristics analyzation circuitry 212 sends characteristics corresponding to application A when the power consumption is estimated for application A, and sends characteristics corresponding to application B when the power consumption is estimated for application B.

As described above, application characteristics refer to at least one of a priority level of the application, theoretical power profile given to the application, service level objectives of the application, allotted resource usage for the application, allotted number of cores the application can use, and data-intensity of the application. In some examples, the application characteristics analyzation circuitry 212 selects which application characteristics to send to the power consumption estimation circuitry 218 based on the inputs 108. For example, a user may provide preferences for estimation of application power consumption that determine how weights (e.g., the core weight and the non-core resource weight) should be adjusted to improve a cost function of the power consumption estimation circuitry 218. A cost function refers to an algorithm or formula that measures the difference between a predicted output and an actual target output. In examples disclosed herein, the cost function of the power consumption estimation circuitry 218 refers to a formula that measures the difference between the estimated power consumption of an application and the actual target power consumption of the application. In some examples, the actual target power consumption of the application can be inferred from the application characteristics. For example, application characteristics might include a theoretical power profile given to the application. Also, the estimated power consumption of the application is determined by the power consumption estimation circuitry 218. The adjustable weights are tweaked in a direction that ideally minimizes the cost function. For example, user preferences may cause the power consumption estimation circuitry 218 to adjust the weights based on the context, determined using application characteristics and core characteristics, the application is run in. Adjusting the weights based on the context the application is run in is described in further detail below.

The application characteristics analyzation circuitry 212 identifies the theoretical power profile of the application under analysis and sends to the power consumption estimation circuitry 218. The theoretical power profile of an application is a predicted graphical representation of how much power an application is expected to consume over time, based on the design and anticipated usage patterns of the application, without real-world data, essentially outlining the expected power consumption under different operating conditions and workload scenarios.

In some examples, the application characteristics analyzation circuitry 212 selects the application priority level of the application under analysis and sends to the power consumption estimation circuitry 218 when the inputs 108 indicate that the priority level of an application should be used to adjust the weights of the core power consumption and the non-core power consumption. In some examples, an application can be assigned one of five priority levels: critical, high, medium, low, and lowest.

In some examples, the application characteristics analyzation circuitry 212 selects the service level objectives of the application under analysis and sends to the power consumption estimation circuitry 218 when the inputs 108 indicate that performance level of an application should be used to adjust the weights of the core power consumption and the non-core power consumption. In some examples, the application characteristics analyzation circuitry 212 selects the allotted resource usage for the application under analysis and sends to the power consumption estimation circuitry 218 when the inputs 108 indicate that amount of resources allotted by an administrator of an application should be used to adjust the weights of the core power consumption and the non-core power consumption. In some examples, the application characteristics analyzation circuitry 212 selects the application intensity to send to the power consumption estimation circuitry 218 when the inputs 108 indicate that the demands of the application and, thus, level of intensity, should be used to adjust the weights of the core power consumption and non-core power consumption.

In some examples, the application characteristics analyzation circuitry 212 sends two or more application characteristics to the power consumption estimation circuitry 218. For example, inputs 108 may indicate more than one application characteristics should be used to determine the context the application is run in and, thus, determine the weights to be applied to core power consumption and non-core resource power consumption.

In some examples, the power estimation circuitry 102 includes means for identifying application characteristics of an application under analysis. For example, the means for identifying application characteristics of an application under analysis may be implemented by application characteristics analyzation circuitry 212. In some examples, the application characteristics analyzation circuitry 212 may be instantiated by programmable circuitry such as the example programmable circuitry 712 of FIG. 7. For instance, the application characteristics analyzation circuitry 212 may be instantiated by the example microprocessor 800 of FIG. 8 executing machine executable instructions such as those implemented by at least block 510 of FIG. 5. In some examples, the application characteristics analyzation circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the application characteristics analyzation circuitry 212 may be instantiated by any other combination of hardware, software, and/or firmware. For example, the application characteristics analyzation circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the application characteristic database 214 stores application characteristics provided by the orchestration and management server 106 (FIG. 1). In some examples, the application characteristic database 214 is a cache located closer to the application characteristics analyzation circuitry 212 and, thus, is quickly accessible. The application characteristic database 214 of FIG. 2 is implemented by any memory, storage device and/or storage disc for storing data such as, for example, flash memory, magnetic media, optical media, solid state memory, hard drive(s), thumb drive(s), etc. Furthermore, the data stored in the application characteristic database 214 may be in any data format such as, for example, binary data, comma delimited data, tab delimited data, structured query language (SQL) structures, etc. While, in the illustrated example, the example application characteristic database 214 is illustrated as a single memory, the application characteristic database 214 and/or any other data storage devices described herein may be implemented by any number and/or type(s) of memories. The application characteristic database 214 may implement the means for storing application characteristics from an orchestration and management server.

In the illustrated example of FIG. 2, the configuration circuitry 216 configures a power estimation method based on the inputs 108. The power estimation method refers to the formula used by the power consumption estimation circuitry 218 to estimate the power consumption of an application. Specifically, the configuration circuitry 216 configures core weights and non-core weights which are used by the power consumption estimation circuitry 218 to generate a power consumption of the application. As described above, the inputs 108 define how the context of the application affects values of the weights. As used herein, the “context of the application” or the “application context” refers to a set of data that defines the environment and specific conditions under which an application is running. For example, a first application context may be high priority level and high busyness (e.g., network packet accessing), a second application context may be a low priority level but high busyness, a third application context may be a high priority level but low busyness, etc.

In some examples, the configuration circuitry 216 receives or obtains the inputs 108 and generates a lookup table, which define how the context of the application affects values of the weights. The lookup table is created by establishing keys that are used to look up and retrieve corresponding values from the table, where the key refers to a pre-defined context and the value corresponds to the weight associated with the key. In some examples, the configuration circuitry 216 determines contexts of the application and then determines a value of the core weight and a value of the non-core resources weight to associate or pair with that context. A core weight is indicative of an impact that the application has on a power consumption of the core. A non-core weight is indicative of an impact that the application has on a power consumption of the non-core resources.

To determine a context of the application, the configuration circuitry 216 obtains and processes the inputs 108. For example, in a first scenario, the inputs 108 indicate that power estimation should focus (1) on the power curve of the cores being used to run the application and (2) on the priority level given to the application. In such an example, the configuration circuitry 216 generates a first context or first key that represents a first power curve of the cores and associates that first context or first key with a core weight value equal to 1 (e.g., cw=1). The configuration circuitry 216 generates a second context or second key that represents the second power curve of the core and associates that second context or second key with a core weight value equal to 0.9 (e.g., cw=0.1), where the first power curve is greater than the second power curve. The configuration circuitry 216 generates a third context or third key that represents a third power curve of the cores and associates that third context or third key with a core weight value equal to 0.1 (e.g., cw=0.1), where the third power curve is the lowest power curve of all power curves associated with the cores. The configuration circuitry 216 continues associating different power curves with different core weight values, where the higher the power curve, the closer the core weight is moved to 1 and the lower the power curve, the closer the core weight is moved to 0.

In the first scenario, the configuration circuitry 216 generates a next context or next key that represents a highest priority level relative to all general application priority levels and associates that context or key with a non-core resource weight value equal to 1 (e.g., ncw=1). The configuration circuitry 216 generates a next context or next key that represents a lowest priority level relative to all general application priority levels and associates that context or key with a non-core resource weight value equal to 0.1 (e.g., ncw=0.1). The configuration circuitry 216 continues associating different priority levels with different non-core weight values, where the higher the priority level of the application, the closer the non-core weight is moved to 1 and the lower the priority level of the application, the closer the non-core weight is moved to 0. This example represents a user preferring that an application with higher priority be attributed with a higher fraction of the total core and non-core resource power consumption than an application with lower priority because high priority applications are allowed to turbo boost and therefore trigger higher power usage of adjacent and shared resources (e.g., non-core resources).

In a second scenario, the inputs 108 indicate that power estimation should focus on the service level objectives of the application. In such an example, the configuration circuitry 216 generates keys based on different service level objectives (SLOs), where a key representing a high or strict SLO is associated with a high core weight (e.g., cw is closer to 1) and a high non-core weight (e.g., new is closer to 1). This example represents a user preferring that an application with strict SLOs and, thus, a high-performance profile, will be attributed with a higher fraction of the total core and non-core resource power consumption than an application with looser SLOs (e.g., with lower performance profiles).

In a third scenario, the inputs 108 indicate that power estimation should focus on the application intensity of the application. In such an example, the configuration circuitry 216 generates keys based on the level of data intensity given to the application, where a key representing a data intensive application is associated with a high non-core weight (e.g., ncw is closer to 1) and a key representing a non-intensive application is associated with a lower non-core weight (e.g., ncw is closer to 0). This example represents a user preferring that an application deemed data intensive will be attributed with a higher fraction of the total non-core resource power consumption than an application deemed non-intensive. This is because a data intensive application causes the powerup of the non-core resources and further causes the non-core resources to be “busy”. As mentioned above, busyness is identified based on the level of activity the core dedicated to processing network packets.

The three scenarios described above were just a few examples, but the configuration circuitry 216 can configure any number of keys and any combination of scenarios based on the inputs 108. For example, the configuration circuitry 216 can configure the keys in the lookup table based on any core characteristics, including but not limited to the identifier number of the core (e.g., CPUID, SKU information, etc.), time the core spends in an idle power saving mode (e.g., C-state residency), time the core spends in a performance mode (e.g., P-state residency), and a level of activity the core dedicated to processing network packets (e.g., busyness of the core). Additionally, the configuration circuitry 216 can configure the keys in the lookup table based on any application characteristics, including but not limited to priority level of the application, theoretical power profile given to the application, service level objectives of the application, allotted resource usage for the application, allotted number of cores the application can use, and data-intensity of the application.

In some examples, the configuration circuitry 216 generates a lookup table for core weights (cw) and a separate lookup table for non-core resource weights (ncw) based on the user preferred contexts. In some examples, the configuration circuitry 216 generates a lookup table for non-core resource weights and the power consumption estimation circuitry 218 dynamically adjusts the non-core weights further based on observability mechanisms, such as perf or CMT. For example, the application characteristics analyzation circuitry 212 can observe an application for its use of non-core resources, such as last level cache or memory accesses, and the power consumption estimation circuitry 218 can use this data to adjust the non-core weight obtained from the non-core resource lookup table.

In some examples, the configuration circuitry 216 implements a machine-learning (ML) model or artificial intelligence (AI) model that predicts the core weight and the non-core weight based on the core characteristics and the application characteristics. In such an example, the ML/AI model may be trained using user inputs 108, core characteristics, and application characteristics. For example, in supervised learning, the inputs 108 may represent labels corresponding expected (e.g., labeled) outputs of the ML/AI model to help the model to select parameters (e.g., by iterating over combinations of select parameters) that reduce model error. The training data is the core characteristics and application characteristics that the ML/AI model is to infer patterns (e.g., contexts) from. In examples where the configuration circuitry 216 implements an ML/AI model to generate core weights and non-core weights, the configuration circuitry 216 does not generate lookup tables.

In some examples, the power estimation circuitry 102 includes means for configuring core weights and non-core weights based user preferences and based on characteristics of the core and the application. For example, the means for configuring core weights and non-core weights based user preferences and based on characteristics of the core and the application may be implemented by configuration circuitry 216. In some examples, the configuration circuitry 216 may be instantiated by programmable circuitry such as the example programmable circuitry 712 of FIG. 7. For instance, the configuration circuitry 216 may be instantiated by the example microprocessor 800 of FIG. 8 executing machine executable instructions such as those implemented by at least blocks 404, 406, 408, and 410 of FIG. 4, and blocks 512 and 514 of FIG. 5. In some examples, the configuration circuitry 216 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the configuration circuitry 216 may be instantiated by any other combination of hardware, software, and/or firmware. For example, the configuration circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the power consumption estimation circuitry 218 estimates power consumption on a per application basis. For example, the power consumption estimation circuitry 218 generates a power estimate value indicative of how much power the application is causing the node 104 to consume, draw, use, etc. The power consumption estimation circuitry 218 uses the application characteristics and the core characteristics, provided by the telemetry analyzation circuitry 204, the resource analyzation circuitry 208, and the application characteristics analyzation circuitry 212 to select the core weights and non-core weights configured by the configuration circuitry 216. In some examples, the power consumption estimation circuitry 218 uses the telemetry data to compute a power estimation function. For example, the power consumption estimation circuitry 218 may implement Equation 1 below to estimate the power consumption of an application.

$$power estimate {app}_{i} = {cw}_{i} \times {power}_{core} \times utilization + \frac{{ncw}_{i} \times {power}_{non - core}}{\# of active cores} \qquad Equation 1$$

In Equation 1, app; refers to application i, cwᵢ refers to the core weight of application i, power_{core} refers to a combined power consumption of the one or more cores executing application i, utilization refers to the resource utilization of the one or more cores executing application i, ncwᵢ refers to the non-core weight of application i, power_{non-core} refers to the power consumption of the non-core resources of the node that are used by the core execution application i, and #of active cores refers to the number of cores in the node that are allocated to the application, that are active, and that share or access the non-core resources.

In some examples, the power consumption estimation circuitry 218 uses the lookup table, generated by the configuration circuitry 216, to determine cwᵢ and ncwᵢ. For example, the power consumption estimation circuitry 218 receives the application characteristics and resource data from the resource analyzation circuitry 208 and the application characteristics analyzation circuitry 212 and uses the data to identify one or more keys in the lookup table that correspond to the resource data and/or application characteristics. The power consumption estimation circuitry 218 can then identify the values of cwᵢ and ncw; based on the keys. In some examples, when the configuration circuitry 216 implements an ML/AI model, the configuration circuitry 216 provides the values of cwᵢ and ncw; to the power consumption estimation circuitry 218. For example, the resource analyzation circuitry 208 and the application characteristics analyzation circuitry 212 may input the resource data and application characteristics to the configuration circuitry 216, and the configuration circuitry 216 generates a first output corresponding to the value of the core weight (cwᵢ) and a second output corresponding to the value of the non-core weight (ncwᵢ).

The power consumption estimation circuitry 218 then uses the telemetry data provided by the telemetry analyzation circuitry 204 to complete the power estimation of the application i. For example, the telemetry data includes the power consumption of the one or more cores executing application i (power_{core}), the resource utilization of the one or more cores executing application i (utilization), the power consumption of the non-core resources of the node that are used by the one or more cores executing application i (power_{non-core}), and the number of cores in the node that are allocated to the application, that are active, and that share or access the non-core resources (#of active cores).

In some examples, the power estimation of the application should be a portion or part of the total power draw of the node 104. For example, when more than one application is executed by the node 104, the power consumption estimation should be less than the total power draw of the node 104, because there may be a second, third, fourth, etc., application also causing a consumption of power, which, when summed, should be equal to the total power draw of the node 104. Alternatively, the power estimation of the application may be equivalent or approximately equivalent to the total power draw of the node 104. For example, when the node 104 executes one application, the power draw of the node 104 is not shared among any other application.

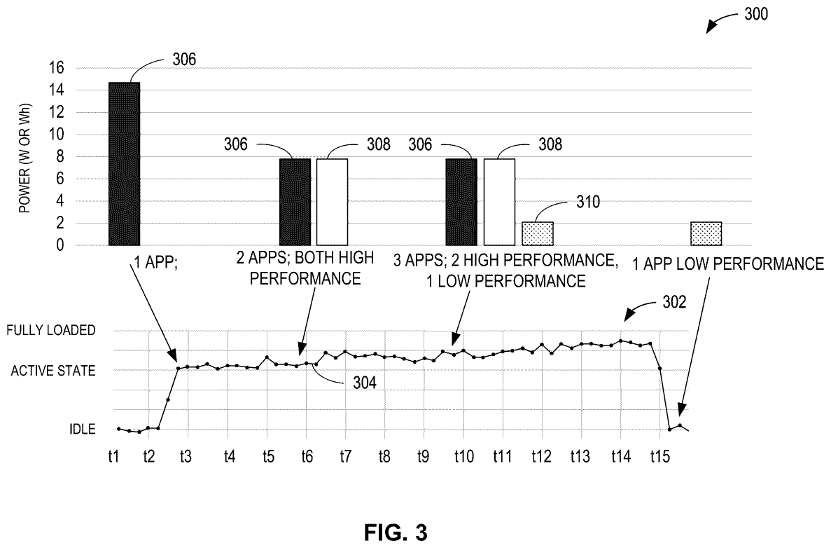

For example, turning to FIG. 3, an example bar graph 300 and an example power signal plot 302 are illustrated to depict a distribution of an example power draw 304 of the node 104 among three different applications running on the node 104. Additionally, the bar graph 300 illustrates how the three different applications might cause the node 104 to draw power. The bar graph 300 of FIG. 3 includes a first application 306, a second application 308, and a third application 310. The power signal plot 302 includes the power draw 304 of the node 104 over a period of time.

The x-axis of the bar graph 300 and of the power signal plot 302 is the time over a power measurement period (e.g., t1-t15) and may represent seconds, minutes, hours or even days depending on the applications. The y-axis of the bar graph 300 is the estimated power consumption of the applications in watts or watts per hour (W/hr). The y-axis of the power signal plot 302 is the level of power draw 304 of the node 104 shown in states, where idle state refers to power drawn when the node 104 is idle (e.g., minimum amount of watts), active state refers to power drawn by the node 104 in an active state, and fully loaded state refers to the maximum amount of power that the node 104 can draw.

In the illustrated example of FIG. 3, at time t1, the node 104 is in an idle state and not drawing and/or consuming a lot of power. When the first application 306 comes in at time t3 (e.g., when the node 104 begins executing the first application 306 at time t3), the first application 306 triggers the node 104 to go active and the power draw 304 increases. The power signal plot 302 illustrates a power jump from idle state to active state. At time t1, the bar graph 300 illustrates that the power estimation of the first application 306 is high (e.g., 15 W).

At time t6, the second application 308 comes in (e.g., the node 104 begins executing the second application 308), and the power draw 304 increases marginally. The power consumption estimation circuitry 218 estimates the power consumption of the first application 306 and the power consumption of the second application 308 at time t5. The bar graph 300 illustrates that the power estimation of the first application 306 decreases from time t3. This is because the power consumption estimation circuitry 218 attributes a portion of the power draw 304 to the second application 308. In this example, the power consumption estimation circuitry 218 determines that the first application 306 and the second application 308 should be equally attributed (e.g., get 50% of the share). In some examples, this may be a result of the first application 306 and the second application 308 having similar application characteristics.

At time t10, the third application 310 comes in (e.g., the node 104 begins executing the third application 310), and the power draw 304 increases marginally over time (e.g., between t10 and t14). The power consumption estimation circuitry 218 estimates the power consumption of the first application 306, the power consumption of the second application 308, and the power consumption of the third application 310 at time t10. The bar graph 300 illustrates that the power estimation of the first application 306 and second application 308 stays the same from time t5, and that the power estimation of the third application 310 is low relative to the first application 306 and second application 308. This is because the power consumption estimation circuitry 218 determines that the first application 306 and second application 308 have application characteristics indicative of causing a higher power draw 304. Additionally, the power consumption estimation circuitry 218 determines that the third application 310 has application characteristics indicative of low power draw. For example, the third application 310 may be an application or workload that runs in the background and, thus, should not be attributed more than 10% of the power draw 304.

At time t15, the node 104 stops executing the first application 306 and second application 308 and the power draw 304 decreases. The node 104 still executes the third application 310, and, as shown by the power draw 304, the third application 310 does not cause the node 104 to consume much power. Therefore, the power consumption estimation circuitry 218 accurately estimated the power consumption of the third application 310 at time t10.

As shown, the power consumption estimation circuitry 218, along with the configuration circuitry 216, distributes the power draw 304 among the applications 306, 308, and 310 in a manner consistent with the characteristics of the application to provide an accurate estimation of the power that each application causes the node 104 to consume.

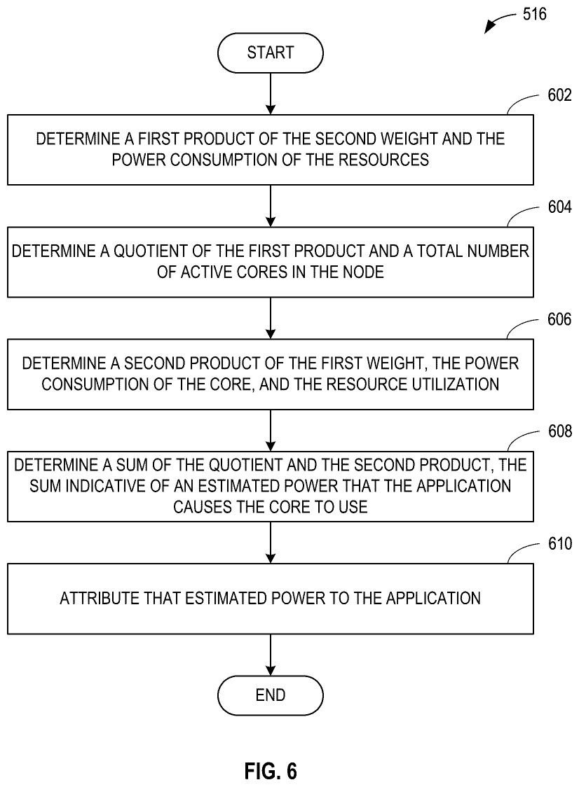

In some examples, the power estimation circuitry 102 includes means for determining a power estimate of an application. For example, the means for determining a power estimate of an application may be implemented by power consumption estimation circuitry 218. In some examples, the power consumption estimation circuitry 218 may be instantiated by programmable circuitry such as the example programmable circuitry 712 of FIG. 7. For instance, the power consumption estimation circuitry 218 may be instantiated by the example microprocessor 800 of FIG. 8 executing machine executable instructions such as those implemented by at least blocks 512, 514, 516 of FIG. 5 and blocks 602, 604, 606, 608, and 610 of FIG. 6. In some examples, the power consumption estimation circuitry 218 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the power consumption estimation circuitry 218 may be instantiated by any other combination of hardware, software, and/or firmware. For example, the power consumption estimation circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Returning to FIG. 2, the power estimates database 220 stores power estimates generated by the power consumption estimation circuitry 218. In some examples, the power estimates database 220 is a cache located closer to the power consumption estimation circuitry 218 and, thus, is quickly accessible. The power estimates database 220 of FIG. 2 is implemented by any memory, storage device and/or storage disc for storing data such as, for example, flash memory, magnetic media, optical media, solid state memory, hard drive(s), thumb drive(s), etc. Furthermore, the data stored in the power estimates database 220 may be in any data format such as, for example, binary data, comma delimited data, tab delimited data, structured query language (SQL) structures, etc. While, in the illustrated example, the example power estimates database 220 is illustrated as a single memory, the power estimates database 220 and/or any other data storage devices described herein may be implemented by any number and/or type(s) of memories. The power estimates database 220 may implement the means for storing power estimations of applications.

While an example manner of implementing the power estimation circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 202, the example telemetry analyzation circuitry 204, the example telemetry database 206, the example resource analyzation circuitry 208, the example resource database 210, the example application characteristics analyzation circuitry 212, the example application characteristic database 214, the example configuration circuitry 216, the example power consumption estimation circuitry 218, the example power estimates database 220, and/or, more generally, the example power estimation circuitry 102 of FIG. 2, may be implemented by hardware alone or by hardware in combination with software and/or firmware. Thus, for example, any of the example interface circuitry 202, the example telemetry analyzation circuitry 204, the example telemetry database 206, the example resource analyzation circuitry 208, the example resource database 210, the example application characteristics analyzation circuitry 212, the example application characteristic database 214, the example configuration circuitry 216, the example power consumption estimation circuitry 218, the example power estimates database 220, and/or, more generally, the example power estimation circuitry 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example power estimation circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the power estimation circuitry 102 of FIG. 2 and/or representative of example operations which may be performed by programmable circuitry to implement and/or instantiate the power estimation circuitry 102 of FIG. 2, are shown in FIGS. 4-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example power estimation circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to generate a lookup table for core weights and non-core weights. The example machine-readable instructions and/or the example operations 400 of FIG. 4 begin at block 402, at which the configuration circuitry 216 obtains user inputs (e.g., inputs 108 of FIG. 1) indicative of a power estimation preference. For example, administrators of a node (e.g., node 104) or administrators of an application may select preferences for estimating the power consumption of the applications. Such preferences are indicative of how to separate weights based on different scenarios of application characteristics and core characteristics, more generally referred to as application contexts.

At block 404, the configuration circuitry 216 determines a number of application contexts based on the user inputs, the application contexts corresponding to a set of data that defines the environment and specific conditions under which an application is running. For example, the configuration circuitry 216 determines how many combinations of application characteristics and core characteristics could exist, given the user inputs. In some examples, the configuration circuitry 216 may determine that five application contexts may exist for a user input that specifies the application priority level should be considered when estimating power consumption of applications. There are five application contexts for five levels of priority: critical, high, medium, low, and lowest. In some examples, there may be more application contexts when priority level is combined with another preference, such as preferring the power estimation to additionally focus on the power curves of the cores being used to run the application. In some examples, the configuration circuitry 216 may identify application contexts that do not relate to user input but that provide assistance in weighting the core power consumption and non-core power consumption. For example, the configuration circuitry 216 may determine that busyness of a core should be a factor to consider when estimating power consumption of an application, and thus, identify application context combinations of priority levels and busyness. The configuration circuitry 216 may identify any number of application contexts.

At block 406, the configuration circuitry 216 generates keys for the number of application contexts. For example, the configuration circuitry 216 may encode the application contexts to generate unique identifiers representative of the application contexts. In some examples, the configuration circuitry 216 may generate unique identifiers for the application contexts in any manner. The number of keys correspond to the number of identified application contexts.

At block 408, the configuration circuitry 216 associates each key with a core weight value and/or a non-core weight value. For example, a core weight value may be any value between 0 and 1, and a non-core weight value may be any value between 0 and 1. The configuration circuitry 216 determines which application context should be associated with which weight value based on the application context. For example, the configuration circuitry 216 generates a key that represents a highest priority level relative to all general application priority levels and associates that key with a non-core resource weight value equal to 1 (e.g., ncw=1), because an application with a higher priority is to be attributed with a higher fraction of the total core and non-core resource power consumption than an application with lower priority.

At block 410, the configuration circuitry 216 generates a lookup table based on the keys and associated weight values. For example, the lookup table includes a key (e.g., an application context) that points to an associated weight value of the core and/or of the non-core resources. The lookup table can be used by the power consumption estimation circuitry 218 (FIG. 2) to weight the power consumption of the core and the power consumption of the non-core resources for an application.

The operations 400 end when the lookup table is generated. However, the operations 400 may be repeated any time new user inputs are received. For example, an administrator may update the preferences for power estimation and, thus, the configuration circuitry 216 may update the lookup table based on those preferences. In some examples, the configuration circuitry 216 does not perform operations 400. For example, when the configuration circuitry 216 implements an AI/ML model to estimate core weight values and non-core weight values, the configuration circuitry 216 does not need to generate a lookup table.

FIG. 5 is a flowchart representative of example machine readable instructions and/or example operations 500 that may be executed, instantiated, and/or performed by programmable circuitry to estimate the power consumption of an application. The example machine-readable instructions and/or the example operations 500 of FIG. 5 begin for each application (blocks 501-518) at block 502, at which the telemetry analyzation circuitry 204 analyzes telemetry data corresponding to the application. For example, the telemetry analyzation circuitry 204 obtains and processes the telemetry data corresponding to the application being estimated.

At block 504, the telemetry analyzation circuitry 204 determines a power draw of the node 104 based on the telemetry data. For example, the telemetry analyzation circuitry 204 determines the power draw of the node 104 based on power consumption metrics, voltage and current readings from a power supply unit of the node 104, etc.

At block 506, the telemetry analyzation circuitry 204 determines a power consumption of a core executing the application based on the telemetry data. For example, the telemetry analyzation circuitry 204 determines the power consumption of a core executing the application based on individual core power usage metrics, such as CPU core power. In some examples, the telemetry analyzation circuitry 204 determines a combined power consumption of the one or more cores executing application.

At block 508 the telemetry analyzation circuitry 204 determines a power consumption of non-core resources based on the telemetry data. For example, for non-core resources that may be utilized by the application, such as last level cache, memory controllers, on-chip interconnect, etc., the telemetry analyzation circuitry 204 determines the power consumption of the non-core resources based on adding power consumption metrics associated with the last level cache, the integrated memory controllers, the on-chip interconnect, and/or the power control logic.

At block 510, the power estimation circuitry 102 (FIG. 1) analyzes resource data and application characteristics corresponding to the application. For example, the resource analyzation circuitry 208 (FIG. 2) extracts unprocessed resource utilization metrics from the data provided by the telemetry data and determines a resource utilization value of the resources of the node 104 based on that data. For example, the resource analyzation circuitry 208 obtains data corresponding to CPU cycles, memory bytes, disk I/O operations, etc., and determines a percentage of usage for each of those resources. The resource analyzation circuitry 208 also analyzes resource allocation data to determine how many cores have been allocated to the application. The resource analyzation circuitry 208 also analyzes resource usage data to determine how many cores an application is executing on and what type of cores an application is executing on (e.g., CPU, accelerator, etc.). The application characteristics analyzation circuitry 212 analyzes the application characteristics data and identifies relevant application characteristics of the application, such as priority level of the application, theoretical power profile given to the application, service level objectives of the application, allotted resource usage for the application, allotted number of cores the application can use, and data-intensity of the application.

At block 512, the power consumption estimation circuitry 218 (FIG. 2) determines a first weight corresponding to the core based on the resource data and application characteristics. For example, the power consumption estimation circuitry 218 uses the lookup table, generated by the configuration circuitry 216, to determine the core weight (cw) by identifying one or more keys in the lookup table that correspond to the resource data and/or application characteristics. In some examples, the configuration circuitry 216 implements an AI/ML model that determines the core weight based on the resource data and/or application characteristics.

At block 514, the power consumption estimation circuitry 218 determines a second weight corresponding to the non-core resources based on resource data and application characteristics. For example, the power consumption estimation circuitry 218 uses the lookup table to determine the non-core weight (ncw) by identifying one or more keys in the lookup table that correspond to the resource data and/or application characteristics. In some examples, the configuration circuitry 216 implements an AI/ML model that determines the non-core weight based on the resource data and/or application characteristics.

At block 516, the power consumption estimation circuitry 218 determines a power estimate for the application based on the telemetry data, the first weight, and the second weight. For example, the power consumption estimation circuitry 218 implements Equation 1, described above and reprinted below, to estimate the power consumption of the application.

$$power estimate {app}_{i} = {cw}_{i} \times {power}_{core} \times utilization + \frac{{ncw}_{i} \times {power}_{non - core}}{\# of active cores} \qquad Equation 1$$

At block 520, after each application has been processed, the interface circuitry 202 reports the power estimates for the applications. For example, the interface circuitry 202 provides the power estimates of the applications to the reporting circuitry 110 (FIG. 1), and the reporting circuitry 110 provides direct access to users and administrators regarding the power consumption of their applications.

FIG. 6 is a flowchart representative of example machine readable instructions and/or example operations 516 that may be executed, instantiated, and/or performed by programmable circuitry to implement the power consumption estimation circuitry 218 of FIG. 2. The example machine-readable instructions and/or the example operations 516 of FIG. 6 begin at block 602, at which the power consumption estimation circuitry 218 determines a first product of the second weight and the power consumption of the non-core resources. For example, the power consumption estimation circuitry 218 applies the non-core weight (ncw) to the power consumption of the non-core resources based on the application characteristics of the application. The non-core weight is used to attribute a percentage of the power consumption of the non-core resources to the application. For example, if the application characteristics indicate that the application is data intensive, then it is likely that the application causes the last level cache and memory controller to operate with more power in order to satisfy the data requirements of the data intensive application and, thus, a higher percentage of the power consumption of the non-core resources should be attributed to that application. On the other hand, when the application is compute intensive but not data intensive, then it is unlikely that the application causes the last level cache and memory controller to operate with more power because a compute intensive application prioritizes complex calculations and requires significant processing power rather than non-core resources power and, thus, a lower percentage of the power consumption of the non-core resources should be attributed to the application. In some examples, the first product is representative of the power consumption of the non-core resources that should attributed to the application.

At block 604, the power consumption estimation circuitry 218 determines a quotient of the first product and a total number of active cores in the node. For example, the core executing the application shares the non-core resources with other cores in the node 104. Therefore, the power consumption estimation circuitry 218 has to attribute some of the power consumption of the non-core resources to other active cores executing different applications in order to determine an accurate power estimate for the application. In some examples, the total number of active cores refers to the number of cores in the node that are allocated to the application, that are active, and that share or access the non-core resources.

At block 606, the power consumption estimation circuitry 218 determines a second product of the first weight, the power consumption of the core, and the resource utilization value. For example, the power consumption estimation circuitry 218 applies the core weight (cw) to the power consumption of the core based on application characteristics and core characteristics. The core weight is used to attribute a percentage of the power consumption of the core to the application. For example, if the application characteristics indicate that the application is compute intensive, the then it is likely that the application causes the core to operate with more power in order to satisfy the computational requirements of the compute intensive application and, thus, a higher percentage of the power consumption of the core should be attributed to that application. The resource utilization also affects how much power consumption of the core should be applied when determining the power estimate of the application.

At block 608, the power consumption estimation circuitry 218 determines a sum of the quotient and the second product, the sum indicative of an estimated power that the application causes the core to use. For example, the quotient is representative of the power consumption of the non-core resources caused by the application, and the second product is representative of the power consumption of the core caused by the application. The sum of these two powers provides the total estimated power draw caused by application.

At block 610, the power consumption estimation circuitry 218 attributes that estimated power to the application. For example, the power consumption estimation circuitry 218 associates the application with that power estimate in order for the interface circuitry 202 (FIG. 2) to report the power estimation.

FIG. 7 is a block diagram of an example programmable circuitry platform 700 structured to execute and/or instantiate the example machine-readable instructions and/or the example operations of FIGS. 4-6 to implement the power estimation circuitry 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example telemetry analyzation circuitry 204, the example resource analyzation circuitry 208, the example application characteristics analyzation circuitry 212, the example configuration circuitry 216, and the example power consumption estimation circuitry 218.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In the illustrated example of FIG. 7, the interface circuitry 720 implements the example interface circuitry 202 of FIG. 2.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In the illustrated example of FIG. 7, the mass storage discs or devices 728 implement the example telemetry database 206, the example resource database 210, the example application characteristic database 214, and the example power estimates database 220.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

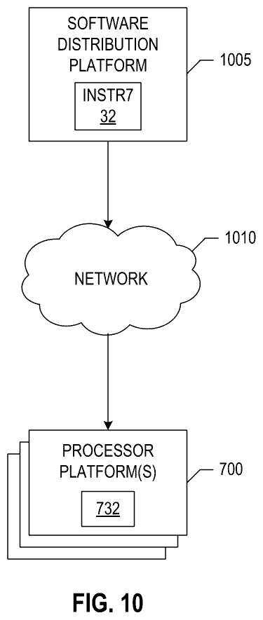

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4-6, may be downloaded to the example programmable circuitry platform 700, which is to execute the machine readable instructions 732 to implement the power estimation circuitry 102. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that estimate the power consumption that an application or workload causes a node to draw. Disclosed systems, apparatus, articles of manufacture, and methods provide a practical application to the problem of reporting inaccurate carbon footprints by providing an accurate estimate of power consumption caused by applications. Disclosed systems, apparatus, articles of manufacture, and methods improve the efficiency of using a computing device by distributing applications and/or workloads across a node based on the power consumption estimation of the applications and/or workloads in a manner that increases power efficiency of the node. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to estimate power consumption of an application in a computing environment are disclosed herein. Further examples and combinations thereof include the following:

Example 1 includes an apparatus comprising interface circuitry to obtain a power draw of a node, to obtain telemetry data of a core in the node, and to obtain an application characteristic of an application, instructions, and at least one programmable circuit to be programmed by the instructions to determine a first weight based on the telemetry data and the application characteristic, the first weight indicative of an impact that the application has on a power consumption of the core, determine a second weight based on the application characteristic of the application, the second weight indicative of an impact that the application has on a power consumption of resources accessible by the core and by one or more different cores of the node, the power consumption of the resources different than the power consumption of the core, and determine a power estimate value for the application based on the first weight, the second weight, the power consumption of the core, and the power consumption of the resources, the power estimate value indicative of how much power of the power draw of the node that the application draws.

Example 2 includes the apparatus of example 1, wherein the resources accessible by the core and by one or more different cores in the node include at least one memory controller of the node and at least one cache of the node.

Example 3 includes the apparatus of any one of examples 1 or 2, wherein one or more of the at least one programmable circuit is to determine the second weight based on a lookup table including the application characteristic and an associated weight for the application characteristic.

Example 4 includes the apparatus of example 3, wherein the lookup table is dynamically adjusted based on a user preference, the user preference indicative of how a first application characteristic impacts the power estimate value for the application versus how a second application characteristic impacts the power estimate value for the application.

Example 5 includes the apparatus of any one of examples 1-4, wherein one or more of the at least one programmable circuit is to increase a value of the second weight to a value closer to 1 when the application characteristic of the application is indicative of a data intensive application relative to a compute intensive application or indicative of a high priority application relative to a medium or low priority application.

Example 6 includes the apparatus of any one of examples 1-5, wherein one or more of the at least one programmable circuit is to decrease a value of the second weight to a value closer to 0 when the application characteristic of the application is indicative of a compute intensive application relative to a data intensive application or indicative of a low or medium priority application relative to a high priority application.

Example 7 includes the apparatus of example 6, wherein one or more of the at least one programmable circuit is to increase a value of the first weight to a value closer to 1 based on the application characteristic indicating that the application is compute intensive.

Example 8 includes the apparatus of any one of examples 1-7, wherein the telemetry data includes the power consumption of the core, the power consumption of the resources, and a number of active cores in the node.

Example 9 includes a non-transitory machine readable storage medium comprising instructions to cause at least one programmable circuit to at least obtain a power draw of a node, telemetry data of a core in the node, and an application characteristic of an application, determine a first weight based on the telemetry data and the application characteristic, the first weight indicative of an impact that the application has on a power consumption of the core, determine a second weight based on the application characteristic of the application, the second weight indicative of an impact that the application has on a power consumption of resources accessible by the core and by one or more different cores of the node, the power consumption of the resources different than the power consumption of the core, and determine a power estimate value for the application based on the first weight, the second weight, the power consumption of the core, and the power consumption of the resources, the power estimate value indicative of how much power of the power draw of the node that the application draws.

Example 10 includes the non-transitory machine readable storage medium of example 9, wherein the resources accessible by the core and by one or more different cores in the node include at least one memory controller of the node and at least one cache of the node.

Example 11 includes the non-transitory machine readable storage medium of any one of examples 9 or 10, wherein the instructions are to cause one or more of the at least one programmable circuit to determine the second weight based on a lookup table including the application characteristic and an associated weight for the application characteristic.

Example 12 includes the non-transitory machine readable storage medium of example 11, wherein the lookup table is dynamically adjusted based on a user preference, the user preference indicative of how a first application characteristic impacts the power estimate value for the application versus how a second application characteristic impacts the power estimate value for the application.

Example 13 includes the non-transitory machine readable storage medium of any one of examples 9-12, wherein the instructions are to cause one or more of the at least one programmable circuit to increase a value of the second weight to a value closer to 1 when the application characteristic of the application is indicative of a data intensive application relative to a compute intensive application or indicative of a high priority application relative to a medium or low priority application.

Example 14 includes the non-transitory machine readable storage medium of any one of examples 9-13, wherein the instructions are to cause one or more of the at least one programmable circuit to decrease a value of the second weight to a value closer to 0 when the application characteristic of the application is indicative of a compute intensive application relative to a data intensive application or indicative of a low or medium priority application relative to a high priority application.

Example 15 includes the non-transitory machine readable storage medium of example 14, wherein the instructions are to cause one or more of the at least one programmable circuit to increase a value of the first weight to a value closer to 1 based on the application characteristic indicating that the application is compute intensive.

Example 16 includes the non-transitory machine readable storage medium of any one of examples 9-15, wherein the telemetry data includes the power consumption of the core, the power consumption of the resources, and a number of active cores in the node.

Example 17 includes a system comprising an orchestration server to orchestrate an execution of an application, a node having one or more cores and resources accessible by the one or more cores, wherein one of the one or more cores is to execute the application, and power estimation circuitry to obtain, from the node, a power draw of the node and telemetry data corresponding to the core executing the application, obtain, from the orchestration server, an application characteristic of the application, determine a first weight based on the telemetry data and the application characteristic, the first weight indicative of an impact that the application has on a power consumption of the core, determine a second weight based on the application characteristic of the application, the second weight indicative of an impact that the application has on a power consumption of resources accessible by the core and by one or more different cores of the node, the power consumption of the resources different than the power consumption of the core, and determine a power estimate value for the application based on the first weight, the second weight, the power consumption of the core, and the power consumption of the resources, the power estimate value indicative of how much power of the power draw of the node that the application draws.

Example 18 includes the system of example 17, wherein the power estimation circuitry is to determine the second weight based on a lookup table including the application characteristic and an associated weight for the application characteristic.

Example 19 includes the system of example 18, wherein the lookup table is dynamically adjusted based on a user preference, the user preference indicative of how a first application characteristic impacts the power estimate value for the application versus how a second application characteristic impacts the power estimate value for the application.

Example 20 includes the system of any one of examples 17-19, wherein the power estimation circuitry is to increase a value of the second weight to a value closer to 1 when the application characteristic of the application is indicative of a data intensive application relative to a compute intensive application or indicative of a high priority application relative to a medium or low priority application.

Example 21 includes the system of any one of examples 17-20, wherein the power estimation circuitry is to decrease a value of the second weight to a value closer to 0 when the application characteristic of the application is indicative of a compute intensive application or a low or medium priority application.

Example 22 includes the system of example 21, wherein the power estimation circuitry is to increase a value of the first weight to a value closer to 1 based on the application characteristic indicating that the application is compute intensive.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to obtain a power draw of a node, to obtain telemetry data of a core in the node, and to obtain an application characteristic of an application;
instructions; and
at least one programmable circuit to be programmed by the instructions to:
determine a first weight based on the telemetry data and the application characteristic, the first weight indicative of an impact that the application has on a power consumption of the core;
determine a second weight based on the application characteristic of the application, the second weight indicative of an impact that the application has on a power consumption of resources accessible by the core and by one or more different cores of the node, the power consumption of the resources different than the power consumption of the core; and
determine a power estimate value for the application based on the first weight, the second weight, the power consumption of the core, and the power consumption of the resources, the power estimate value indicative of how much power of the power draw of the node that the application draws.

2. The apparatus of claim 1, wherein the resources accessible by the core and by one or more different cores in the node include at least one memory controller of the node and at least one cache of the node.

3. The apparatus of claim 1, wherein one or more of the at least one programmable circuit is to determine the second weight based on a lookup table including the application characteristic and an associated weight for the application characteristic.

4. The apparatus of claim 3, wherein the lookup table is dynamically adjusted based on a user preference, the user preference indicative of how a first application characteristic impacts the power estimate value for the application versus how a second application characteristic impacts the power estimate value for the application.

5. The apparatus of claim 1, wherein one or more of the at least one programmable circuit is to increase a value of the second weight to a value closer to 1 when the application characteristic of the application is indicative of a data intensive application relative to a compute intensive application or indicative of a high priority application relative to a medium or low priority application.

6. The apparatus of claim 1, wherein one or more of the at least one programmable circuit is to decrease a value of the second weight to a value closer to 0 when the application characteristic of the application is indicative of a compute intensive application relative to a data intensive application or indicative of a low or medium priority application relative to a high priority application.

7. The apparatus of claim 6, wherein one or more of the at least one programmable circuit is to increase a value of the first weight to a value closer to 1 based on the application characteristic indicating that the application is compute intensive.

8. The apparatus of claim 1, wherein the telemetry data includes the power consumption of the core, the power consumption of the resources, and a number of active cores in the node.

9. A non-transitory machine readable storage medium comprising instructions to cause at least one programmable circuit to at least:
obtain a power draw of a node, telemetry data of a core in the node, and an application characteristic of an application;
determine a first weight based on the telemetry data and the application characteristic, the first weight indicative of an impact that the application has on a power consumption of the core;
determine a second weight based on the application characteristic of the application, the second weight indicative of an impact that the application has on a power consumption of resources accessible by the core and by one or more different cores of the node, the power consumption of the resources different than the power consumption of the core; and
determine a power estimate value for the application based on the first weight, the second weight, the power consumption of the core, and the power consumption of the resources, the power estimate value indicative of how much power of the power draw of the node that the application draws.

10. The non-transitory machine readable storage medium of claim 9, wherein the resources accessible by the core and by one or more different cores in the node include at least one memory controller of the node and at least one cache of the node.

11. The non-transitory machine readable storage medium of claim 9, wherein the instructions are to cause one or more of the at least one programmable circuit to determine the second weight based on a lookup table including the application characteristic and an associated weight for the application characteristic.

12. The non-transitory machine readable storage medium of claim 11, wherein the lookup table is dynamically adjusted based on a user preference, the user preference indicative of how a first application characteristic impacts the power estimate value for the application versus how a second application characteristic impacts the power estimate value for the application.

13. The non-transitory machine readable storage medium of claim 9, wherein the instructions are to cause one or more of the at least one programmable circuit to increase a value of the second weight to a value closer to 1 when the application characteristic of the application is indicative of a data intensive application relative to a compute intensive application or indicative of a high priority application relative to a medium or low priority application.

14. The non-transitory machine readable storage medium of claim 9, wherein the instructions are to cause one or more of the at least one programmable circuit to decrease a value of the second weight to a value closer to 0 when the application characteristic of the application is indicative of a compute intensive application relative to a data intensive application or indicative of a low or medium priority application relative to a high priority application.

15. The non-transitory machine readable storage medium of claim 14, wherein the instructions are to cause one or more of the at least one programmable circuit to increase a value of the first weight to a value closer to 1 based on the application characteristic indicating that the application is compute intensive.

16. The non-transitory machine readable storage medium of claim 9, wherein the telemetry data includes the power consumption of the core, the power consumption of the resources, and a number of active cores in the node.

17. A system comprising:
an orchestration server to orchestrate an execution of an application;
a node having one or more cores and resources accessible by the one or more cores, wherein one of the one or more cores is to execute the application; and
power estimation circuitry to:
obtain, from the node, a power draw of the node and telemetry data corresponding to the core executing the application;
obtain, from the orchestration server, an application characteristic of the application;
determine a first weight based on the telemetry data and the application characteristic, the first weight indicative of an impact that the application has on a power consumption of the core;
determine a second weight based on the application characteristic of the application, the second weight indicative of an impact that the application has on a power consumption of resources accessible by the core and by one or more different cores of the node, the power consumption of the resources different than the power consumption of the core; and
determine a power estimate value for the application based on the first weight, the second weight, the power consumption of the core, and the power consumption of the resources, the power estimate value indicative of how much power of the power draw of the node that the application draws.

18. The system of claim 17, wherein the power estimation circuitry is to determine the second weight based on a lookup table including the application characteristic and an associated weight for the application characteristic.

19. The system of claim 18, wherein the lookup table is dynamically adjusted based on a user preference, the user preference indicative of how a first application characteristic impacts the power estimate value for the application versus how a second application characteristic impacts the power estimate value for the application.

20. The system of claim 17, wherein the power estimation circuitry is to increase a value of the second weight to a value closer to 1 when the application characteristic of the application is indicative of a data intensive application relative to a compute intensive application or indicative of a high priority application relative to a medium or low priority application.
